(19) United States
(12) Patent Application Publication
(10) Pub. No.: US 2019/0124939 A1
(43) Pub. Date: May 2, 2019

(54) STORAGE STABLE FOOD COMPOSITIONS

(71) Applicant: Byron Food Science Pty Limited, Bowral, NS (AU)

(72) Inventors: Deborah Ann LEWIS, Borwal (AU); David Adrian LEWIS, Borwal (AU)

(73) Assignee: Byron Food Science Pty Limited, Bowral, NS (AU)

(21) Appl. No.: 16/092,081

(22) PCT Filed: Apr. 11, 2017
(86) PCT No.: PCT/AU2017/050318

§ 371 Date: Oct. 8, 2018

(30) Foreign Application Priority Data
Apr. 15, 2016 (AU) 2016901402

(51) Int. Cl. A23B 7/01; A23B 7/04; A23B 7/10; A23B 7/14; A23L 3/015

(52) U.S. Cl. CPC A23B 7/01; A23B 7/04; A23V 2002/00; A23B 7/14; A23L 3/015; A23B 7/10

(57) ABSTRACT

Disclosed herein is a method for preparing a ready to use storage stable food composition. The method comprises comminuting an admixture of a fresh plant material and an oil at a substantially neutral pH and under conditions whereby browning enzymes in the plant material are substantially prevented from reacting; rapidly heating the admixture to a temperature at which the browning enzymes are substantially inactivated, and under conditions whereby the admixture loses substantially no weight during heating; and cooling the heated admixture to a temperature at which growth of spoilage organisms does not occur. Also disclosed herein are ready to use storage stable food compositions. When the compositions are combined with foods containing phenolic compounds, no browning of the food occurs.

### TECHNICAL FIELD

The present invention relates to ready to use storage stable food compositions, and to methods for preparing ready to use storage stable food compositions. In a particular form, the invention relates to ready to use chilled or frozen pestos and methods for preparing ready to use chilled or frozen pestos.

### BACKGROUND ART

Plant materials such as herbs, spices, fruits and vegetables are common ingredients in many recipes, with their organoleptic properties (e.g. flavours, colours, aromas and textures) and nutrients being highly prized. Unfortunately, however, many fresh herbs, spices, fruit and vegetables are often only seasonally available and spoil relatively quickly. It has therefore been an enduring challenge in the art to provide storage stable herbs, spices, fruit and vegetables, but without adversely affecting their prized organoleptic properties.

Many herbs, spices, fruit and vegetables (or seasoning compositions containing herbs or spices) can also interact with foods during cooking, resulting in off-colours and off-flavours. For example, some herbs or spices will rapidly turn brown when chopped up and, when added to food, cause the food to become brown or black from contact with the herbs or spices. Such discolouring can make the food unappetising to a consumer and is often accompanied by nutrient losses in the food. Fresh basil pestos, for example, usually need to be prepared immediately before use and the chopped basil stored in olive oil in order to prevent it from rapidly browning and developing off-flavours. When added to a pasta dish, however, the pesto will start to turn brown relatively quickly and will also cause the pasta to turn brown and become bitter in flavour. Whilst the browning may not be noticed by a consumer if the meal is eaten quickly, it necessitates that pestos and pesto containing meals be freshly prepared to order.

This phenomenon was observed by Harold McGee in his book “The Curious Cook” (p 65-73, 1990, Northpoint Press, San Francisco). Despite extensive efforts, he was unable to prepare a pesto that tasted acceptable and which did not cause browning of pasta upon mixing.

It would be advantageous to provide fresh plant material-containing food compositions that are storage stable under appropriate conditions, but which retain the prized organoleptic properties of the fresh plant material and which do not themselves turn brown nor cause browning of foods with which they are mixed.

### SUMMARY OF THE INVENTION

In a first aspect, the present invention provides a method for preparing a ready to use storage stable food composition. The method comprises:
comminuting an admixture of a fresh plant material (e.g. a herb, spice, fruit and/or vegetable) and an oil at a substantially neutral pH and under conditions whereby browning enzymes in the plant material are substantially prevented from reacting;
rapidly heating the admixture to a temperature at which the browning enzymes are substantially inactivated, under conditions whereby the admixture loses substantially no weight during heating; and
cooling the heated admixture to a temperature at which growth of spoilage organisms does not occur.

In a second aspect, the present invention provides a ready to use storage stable food composition, prepared using the method of the first aspect of the present invention.

In a third aspect, the present invention provides a ready to use storage stable food composition. The composition comprises a comminuted mixture of a fresh plant material and an oil, contains substantially no active browning enzymes, has a substantially neutral pH and a water activity greater than 0.91.

In a fourth aspect, the present invention provides a ready to use storage stable food composition. The composition comprises a comminuted mixture of a fresh plant material and an oil but, when the composition is combined with a food containing phenolic compounds, no browning of the food occurs.

The present invention arose from the inventors' (and others) observations that contact with many kinds of herbs or spices can make some foods (e.g. pasta, rice, potatoes, bread, etc., as described in further detail below) turn a brown colour. Upon further investigation, it was found that this browning is mainly caused by browning enzymes in the herbs or spices (primarily the polyphenol oxidase (PPO) systems in many fresh herbs and spices) reacting with phenolic compounds naturally present in the foods to produce brown or black melanins. Some vegetables, especially broccoli, spinach, kale and other green leafy vegetables, also contain relatively high proportions of browning enzymes, and hence may cause a similar effect. Similarly, some culinary fruits like avocado, eggplant and banana, for example, have very active browning enzyme systems and may therefore also cause a similar effect.

Herb or spice preparations containing inactivated browning enzymes may not cause such browning. However, many of the existing enzyme-inactivated herb or spice preparations on the market are unsatisfactory substitutes for fresh herbs or spices in many cooking applications because, for the reasons discussed in detail below, they lose their fresh characteristics during enzyme inactivation. Furthermore, many of the existing herb or spice preparations on the market contain herbs or spices in which the enzymes have merely been inhibited, and which do not prevent food browning from occurring because the activity of the inhibited browning enzymes can return when mixed with food.

The inventors have discovered that it is possible for storage stable herb or spice-containing seasoning compositions to retain the fresh organoleptic and nutritional properties of the fresh herb or spice, but with their browning enzymes having been permanently inactivated. The inventors have extended these findings to fresh fruits and vegetables which contain relatively high proportions of browning enzymes, and especially those having delicate flavours and textural properties which can be detrimentally affected by existing treatment processes. The present invention provides ready to use storage stable food compositions in which the comminuted plant material (e.g. herb, spice and/or vegetable) is maintained in a substantially fresh state, but in which there are substantially no active browning enzymes. There is therefore no need for the composition to contain browning enzyme inhibiting or inactivating agents which, as discussed below, can adversely affect the composition. Compositions of the present invention do not cause browning, either of the plant material itself upon storage in air, or of food with which the food composition is subsequently mixed. As such, when compositions of the present invention are added to foods containing phenolic compounds, no browning of the foods (or the plant material) occurs.

The compositions of the present invention are storage stable under appropriate conditions (storage conditions are dependent on the plant material and method used, as is described in further detail below), with substantial retention of natural colours, flavours, nutrients, functional and aromatic qualities of the plant material(s), but totally or substantially lack active browning enzyme systems. Despite having been heat treated to inactivate the browning enzymes, the composition retains substantially all of the native composition of the fresh plant material, with no loss of solids and moisture content. Further, as the food composition is cooled to a temperature at which growth of spoilage organisms does not occur (e.g. by cooling to below about 0° C.), its water activity does not need to be controlled using water activity controlling agents which, as also described below, can also adversely affect the composition. To the best of the inventors' knowledge, this combination of properties in a fresh plant material-containing food composition is unique.

In some embodiments, the comminution may occur under anoxic conditions. Preventing oxygen from interacting with the browning enzymes can substantially prevent them from reacting (i.e. causing browning products) during comminution (as well as post-comminution and at the beginning of the heating process, provided the conditions remain anoxic), at which time conditions are highly favourable for browning to occur.

In some embodiments, an antioxidant may be added to the admixture before comminution. Such an antioxidant can substantially prevent oxygen from being able to allow browning enzyme activity, and hence browning reactions, whilst the enzymes are still active, especially during and post-comminution and at the beginning of the heating process.

As would be appreciated, herbs and spices are especially susceptible to browning (and the associated spoilage) once their structural integrity has been compromised by comminution and before their browning enzymes are heat inactivated. Performing the comminution under anoxic conditions and/or in the presence of an antioxidant may substantially prevent browning reactions during this period.

In some embodiments, a pH adjusting agent may be added to the admixture (e.g. before comminution). The food compositions of the present invention should ideally be comminuted and heated at a substantially neutral pH (and remain at a substantially neutral pH) because, as described herein, the prized colour, flavour, aroma and texture of the plant material might be compromised by conditions which are acidic or too alkaline.

In some embodiments, the admixture may be rapidly heated to the temperature at which browning enzymes are substantially inactivated by exposing the admixture to, for example, microwave radiation, by exposing the admixture to a hot fluid (e.g. immersing a package containing the comminuted mixture in a hot fluid bath) or by heating the admixture in a heat exchanger.

In some embodiments, the composition may be hyperbarically processed once cooled (either immediately afterwards or some time afterwards, provided that the composition has been stored under appropriate conditions). A usefully long shelf-life of up to about 6 weeks at refrigerator temperatures (e.g. 4 to 8° C.) can be achieved by subjecting the composition to hyperbaric processing. Such processing may therefore enable food compositions of the present invention to be storage stable under chilled conditions.

In some embodiments, the amount of oil in the admixture is sufficient to make a frozen food composition scoopable or pumpable, thus making it extremely simple and convenient for the end user to use, even directly from the freezer. As discussed below, other factors such as the type of oil and presence of other ingredients (e.g. small quantities of salt) in the admixture or composition may also affect the scoopability or pumpability of the composition.

In some embodiments, one or more other foods may be added to the admixture (either before or after comminution). Such other foods may include pine nuts, peanuts, walnuts (and other nuts), cheeses (e.g. Parmesan cheese), dairy or non-dairy powders and combinations thereof. Fruits and vegetables not having particularly active browning enzyme systems or being susceptible to loss of organoleptic properties may also be added to the admixture. For example, in embodiments where the composition is a pesto, other foods which would likely be included are garlic, pine nuts and Parmesan cheese.

In a fifth aspect, the present invention provides a ready to use storage stable food composition. The composition contains substantially no active browning enzymes, has a substantially neutral pH and a water activity of greater than 0.91, and consists essentially of a comminuted mixture of:
between about 5 and about 90 wt % of a fresh plant material;
between about 10 and about 95 wt % of an oil;
between 0 and about 5 wt % of an antioxidant;
between 0 and about 5 wt % of a pH adjusting agent; and
between 0 and about 60 wt % of other foods.

In some embodiments of the fifth aspect of the present invention, the composition is as described herein with reference to the food composition of the second, third or fourth aspect of the present invention.

In a sixth aspect, the present invention provides a container comprising a plurality of servings of the storage stable food composition of the second, third, fourth or fifth aspect of the present invention.

In a seventh aspect, the present invention provides a mixture comprising the storage stable food composition of the second, third, fourth or fifth aspect of the present invention and a food base.

The present invention involves cooling and storing the heated composition under conditions whereby growth of spoilage organisms does not occur, which typically involves cooling and storing the composition at temperatures of between about −10 and about −20° C.). As noted above, however, a usefully long shelf-life of up to about 6 weeks under refrigeration (e.g. 4 to 8° C.) can be achieved by subjecting the post-heated admixture to hyperbaric processing. Accordingly, in an eighth aspect, the present invention provides a method for preparing a ready to use storage stable seasoning composition. The method comprises:
comminuting an admixture of a fresh herb or spice and an oil at a substantially neutral pH and under conditions whereby browning enzymes in the herb or spice are substantially prevented from reacting;
rapidly heating the admixture to a temperature at which the browning enzymes are substantially inactivated, whereby the composition loses substantially no weight during heating;
cooling the heated admixture; and
hyperbarically processing the cooled admixture.

With the exception of the hyperbaric processing step, embodiments of the eighth aspect of the present invention may be as described herein with reference to the method of the first aspect of the present invention. Similarly, with the exception of not usually needing to be stored under frozen conditions, ready to use storage stable food compositions prepared in accordance with the eighth aspect of the present invention may be as described herein with reference to the food composition of the second, third or fourth aspect of the present invention.

In other aspects, the present invention may relate to ready to use frozen seasoning compositions, as well as to methods for preparing ready to use frozen seasoning compositions. These other aspects are described below.

In one aspect, the present invention provides a method for preparing a ready to use frozen seasoning composition. The method comprises:
comminuting an admixture of a fresh herb or spice and an oil at a substantially neutral pH and under conditions whereby browning enzymes in the herb or spice are substantially prevented from reacting;
rapidly heating the admixture to a temperature at which the browning enzymes are substantially inactivated, whereby the composition loses substantially no weight during heating; and
cooling the heated admixture to a temperature at which growth of spoilage organisms does not occur.

In another aspect, the present invention provides a ready to use frozen seasoning composition, prepared using the method of the first aspect of the present invention.

In another aspect, the present invention provides a ready to use frozen seasoning composition. The composition comprises a comminuted mixture of a fresh herb or spice and an oil, contains substantially no active browning enzymes, has a substantially neutral pH and a water activity greater than 0.91.

In another aspect, the present invention provides a ready to use frozen seasoning composition. The composition comprises a comminuted mixture of a fresh herb or spice and an oil but, when the composition is combined with a food containing phenolic compounds, no browning of the food occurs.

In another aspect, the present invention provides a ready to use frozen seasoning composition. The composition contains substantially no active browning enzymes, has a substantially neutral pH and a water activity of greater than 0.91, and consists essentially of a comminuted mixture of:
between about 5 and about 90 wt % of a fresh herb or spice;
between about 10 and about 95 wt % of an oil;
between 0 and about 5 wt % of an antioxidant;
between 0 and about 5 wt % of a pH adjusting agent; and
between 0 and about 50 wt % of other foods.

Other aspects, embodiments and advantages of the present invention will be described below.

### DESCRIPTION OF EMBODIMENTS

The present invention provides a method for preparing a ready to use storage stable food composition. The method comprises:
comminuting an admixture of a fresh plant material and an oil at a substantially neutral pH and under conditions whereby browning enzymes in the plant material are substantially prevented from reacting (i.e. with the plant material itself or with any other components in the admixture);
rapidly heating the admixture to a temperature at which the browning enzymes are substantially inactivated, and under conditions whereby the admixture loses substantially no weight during heating; and
cooling the heated mixture to a temperature at which growth of spoilage organisms does not occur.

The present invention also provides ready to use storage stable food compositions. In one aspect, the ready to use storage stable food composition is prepared using the method of the present invention. In another aspect, the ready to use storage stable food composition comprises a mixture of a fresh plant material and an oil, contains substantially no active browning enzymes, has a substantially neutral pH and a water activity of greater than 0.91. In yet another aspect, the ready to use storage stable food composition comprises a mixture of a fresh plant material and an oil and, when the composition is combined with a food containing phenolic compounds, no browning of the food occurs. In a further aspect, the ready to use storage stable food composition contains substantially no active browning enzymes, has a substantially neutral pH and a water activity of greater than 0.91, and consists essentially of a comminuted mixture of:
between about 5 and about 90 wt % of a fresh plant material;
between about 10 and about 95 wt % of an oil;
between 0 and about 5 wt % of an antioxidant;
between 0 and about 5 wt % of a pH adjusting agent; and
between 0 and about 60 wt % of other foods.

Despite having been comminuted, mixed with other components and heated, the plant materials (e.g. herb, spice, fruit or vegetable) in the compositions of the present invention retains a vast majority of the organoleptic, compositional and nutritional properties of the original plant material. The (comminuted) plant material in the compositions of the present invention has substantially no active browning enzymes, but is not dried and nor has it lost its colour or flavour (e.g. due to storage with preservatives such as acidulants, etc., as is required in existing seasoning compositions). The plant material in the compositions of the present invention has also not been exposed to long heat preservation treatments and/or high pasteurisation or sterilisation temperatures.

To the best of the inventors' knowledge, storage stable food compositions having such features and attributes have not previously been able to be prepared. As disclosed herein, the present inventors have discovered a number of methods via which compositions having these desirable attributes may be prepared.

As used herein, the phrase “storage stable” is to be understood to mean that the resultant composition has a useful shelf life when stored under the recited conditions. The inventors have found that compositions stored in a freezer still have excellent properties even after two years, however, commercially useful storage times may be as short as 4-6 weeks.

As used herein, the phrase “plant material” is to be understood to mean material from a plant which may be used as a food or to season a food, and which contains a relatively high amount of browning enzymes (i.e. an amount of browning enzymes whereby mixing of the plant material with a food makes it and/or the food turn a brown colour). Plant materials which benefit most from the present invention are those having delicate or labile flavours, textures and nutritional properties that are adversely affected by heating or conventional treatments. As will be described in further detail below, exemplary plant materials include herbs, spices, fruits and vegetables, with the delicate and labile flavours and characteristics of herbs and spices making the invention especially applicable to them.

As used herein, the phrase “food composition” is to be understood to mean a composition comprising edible components. The food composition may be intended for consumption as a standalone food product, or may be provided in the form of a concentrate or seasoning composition (or the like), which is intended to be added to other food products in order to season (or otherwise enhance the taste of) the food product.

As will be described below, the food compositions of the present invention may, in some embodiments, be provided in the form of ready to use frozen seasoning compositions. As used herein, the phrase “frozen seasoning composition” is to be understood to mean a seasoning composition that is stored under conditions at which any water component of the composition would freeze (i.e. maintained at a temperature of below 0° C.), and not to the physical form of the seasoning composition. As will be appreciated, seasoning compositions having relatively high proportions of oil, or other melting point lowering agents (e.g. salt), might exist under such conditions in a “semi-frozen” state, where their viscosity is greater than would be the case at room temperature but the composition is not physically frozen (i.e. frozen solid).

As used herein, the phrase “herb or spice” is to be understood to encompass one or more herbs, one or more spices or a combination of herb(s) and spice(s). Thus, a composition of the present invention which includes “a herb or spice” is intended to encompass compositions including one or more herbs, one or more spices and combination of herb(s) and spice(s). Herbs and spices are those edible plants or plant parts that have highly aromatic and pungent flavour qualities, but also very active enzymes including polyphenol oxidase (PPO), in their fresh state.

As used herein, the term “browning enzyme” is to be understood to mean an enzyme contained in the plant material that is capable of causing reactions with phenolic compounds and other browning substrates in the plant material itself, as well as with other foods brought into contact with the enzyme. As a result of those reactions, the plant material and/or food is caused to turn a brown colour and typically develop off-flavours. Activating browning enzymes causes enzymatic browning via a cascade of reactions typically starting with the browning enzyme polyphenol oxidase (PPO), but also involving browning products of the browning enzyme and other enzymes (e.g. transaminases, chlorollphylase and lipoxegenase) and their substrates capable of producing browning products (this phenomenon is described, for example, at p 492-494, 993 in Food Chemistry O. Fennema 3rd Ed 1996).

As used herein, the term “ready to use” is to be understood to mean that the composition requires no further processing before it can be used in its desired application.

As used herein, the term “substantially neutral pH” is to be understood to mean a pH of between about 6.5 and about 8. If the pH of the food composition of the present invention drops below about 6.5 or rises above about 7.5 or 8, then the intrinsic qualities of the plant material (especially for herbs or spices) might be adversely affected.

Storage stable plant materials must not spoil under their indicated storage conditions. Spoilage typically initially involves the plant material developing off-colours and flavours. For example, basil will lose its distinctive green colour as it spoils, turning a brown or black colour and producing undesirable off-flavour and textural changes like softening.

As noted above, the cause of such undesirable browning and off-flavour development of fresh herbs, spices, vegetables and other plant materials falling within the scope of the present invention is mainly due to browning enzyme activity (in particular polyphenol oxidase (PPO) activity). This enzyme activity increases when the fresh plant material is macerated, cut or chopped because the PPO is exposed to the phenolic compounds in the cut cells and, in the presence of oxygen, will react rapidly, especially because of the greater surface area of the damaged plant material exposed to oxygen. This enzyme activity also increases as the temperature is raised to about 60° C. (after which their activity starts to reduce due to enzyme inactivation). Whilst browning colours are the most commonly observed, other unacceptable colours, such as blue-green hues in alliums like garlic, can develop. Other enzymes, such as lipases and lipoxygenases, chlorophyllase, cellulases, proteases, lyases, glucosidases and galacturonase, for example, can also cause instability of flavours, colours, nutrients and textures in some plant materials if left active, and should therefore also be inactivated (if present). In most cases, inhibition or inactivation of browning enzymes is sufficient to cause a corresponding inhibition or inactivation of these other spoiling enzymes.

Overcoming the negative effects of PPO (and other enzymes) has been an enduring challenge in the food industry. A number of techniques are commonly used to prevent spoilage of herbs or spices, for example, including drying of the herb or spice, inhibiting the activity of spoiling enzymes in the herb or spice using acidulants (which inhibit PPO activity, for example, by lowering the pH) or preservatives (e.g. sulphur dioxide, although the negative effects of sulphur dioxide, such as it potentially causing dangerous allergies and its non-organic status, have brought it into disfavour with consumers), inactivating spoiling enzymes in the herb or spice (e.g. by heating), or via combinations of these techniques. The activity of spoiling enzymes in the herb or spice may also be inhibited by freezing the herb or spice. However, many of these techniques result in storage stable herbs or spices that bear little resemblance to the fresh herbs or spices, visually or organoleptically.

For example, state of the art chemical-based techniques for controlling PPO in processed herbs or spices involve a combination of ascorbic acid, citric acid and heat treatment. However, consumers often find that depressed pH and an acidic taste detracts from the delicate natural flavour of herbs or spices. In addition, there are many herbs and spices which have unstable colour molecules when the pH of the products is acidic. For example, chlorophyll-containing herbs like green basil, parsley, mint and many others irreversibly change from being bright green to being olive/brown under acid conditions.

As noted above, another technique commonly used for preventing spoilage of herbs or spices involves drying the herb or spice. However, such drying typically results in a herb or spice that retains very little of its fresh flavour and aroma because heating during drying typically drives off the volatile flavour and aroma components of the herb or spice before its moisture. Drying also hardens the texture of the herb or spice and, in many culinary applications, the dried herb or spice may not rehydrate sufficiently. Further, partially dried herbs or spices are still susceptible to microbial spoilage and therefore would typically also require preservatives of the like discussed below in order to reduce their water activity to inhibit microbial storage.

As noted above, heating of herbs or spices has also been used in order to inhibit or inactivate browning enzymes such as PPOs. However, conventional heat treatment of herbs or spices (e.g. steaming or water blanching or retorting and traditional pasteurisation) can often result in undesirable lipid oxidation and destroy or leach away the delicate and labile aromatic flavours which are characteristic and prized in these herbs or spices. For example, commercially available shelf-stable herb or spice products require stabilisation by acidulating at a pH of less than 4.3, as well as long heating regimes (10-20 minutes or longer) at 90° C. or higher for pasteurisation. Such treatments can destroy the structural integrity of the herb or spice, causing it to lose its fresh texture, and can also adversely affect its fresh flavour and colour because the volatile flavour and aroma components of the herb or spice are driven off or destroyed. Furthermore, in addition to reducing the quality attributes of the herb or spice, as mentioned above, these pre-treatments are also expensive and therefore increase the cost of the final products.

The activity of spoiling enzymes in fresh herbs or spices may also be inhibited by freezing the herb or spice. However, whilst the enzymes remain inhibited and microbial activity stabilised whilst frozen, thawing of the herb or spice causes the enzymes and microbes (and their spores) to become active again. Further, as freezing the herb or spice would typically cause rupturing of the cells in the herb or spice, the no-longer-inhibited browning enzymes are exposed to the phenolic compounds inside the cells and browning therefore occurs very rapidly upon thawing.

In the present invention, it is not necessary to use acidulants or preservatives to inhibit enzyme activity because the enzymes have been inactivated (e.g. during the heating step in the method of the present invention). The inventors have discovered that if a heat treatment to substantially inactivate browning enzymes (which, as noted above, also inactivates substantially all other potential spoiling enzymes) is carried out in the presence of an oil and under conditions where the composition loses substantially no weight during heating, then the delicate and labile aromatic flavours which are characteristic and prized in many plant materials (and especially in herbs and spices), and which may otherwise be driven out of the plant material during comminution and heating, tend to become entrained in the oil and thereby retained by the composition. As such, the inventors have discovered that it is possible to produce food compositions containing plant material (e.g. herb- or spice-containing seasoning compositions) in which the browning enzyme systems have been substantially inactivated (i.e. by heating), but in which the plant material retains its/their prized organoleptic properties, and in the substantial absence of the traditionally used enzyme-controlling substances. As the browning enzymes have been permanently inactivated by heating, they can no longer cause the composition (or phenolic-compound-containing foods to which the composition is added) to discolour and spoil, even when thawed and mixed with other foods.

In the present invention, substantially no drying of the pant material occurs and the plant material retains essentially the totality of its fresh components, meaning that the plant material in the ready to use storage stable food composition (e.g. the herb or spice in the ready to use seasoning compositions) has organoleptic, nutritional and textural properties similar to those of the original fresh plant material. For example, as the plant material is effectively not dried during preparation of the composition comprising the comminuted fresh plant material, it does not need to rehydrate when added to food (as noted above, dried herbs or spices often only partially rehydrate when added to food and therefore often have undesirable physical or organoleptic properties).

Furthermore, during preparation of the food compositions of the present invention, the browning enzymes are inhibited from the outset, with the inhibited browning enzymes being permanently and irreversibly inactivated during heating. The inventors have found that such an immediate inhibition is important because if any browning occurs, even to a small extent, during preparation of the composition (i.e. before the enzymes are inactivated by heating), the browning products and their associated intermediates may remain in the composition and thus can also cause browning of foods. In the method of the present invention, browning enzyme activity is inhibited, and hence substantially prevented, right from the start, so that no such intermediate browning products have the opportunity to form.

Storage stable food compositions must also not be capable of becoming microbially spoiled under their indicated storage conditions. Many techniques are currently used to prevent microbial spoilage of food products containing herbs or spices. For example, herbs or spices may be dried to below a certain moisture content such that microbes cannot grow. Alternatively (or in addition), the water activity of the herb or spice can be lowered to below a level such that microbes cannot grow by using preservatives such as acids, salts or humectants such as sugar and polyols and other solutes. As noted above, however, drying herbs and spices often results in a product which is far less appetising than the fresh herbs and spices. Further, water activity controllers such as acidulants, salts and humectants typically adversely affect the colour, fresh texture and flavour of herbs and spices and, if present in relatively high amounts, may have detrimental health effects. For example, concentrations of 10-15 wt % sodium chloride may be required in order to reduce a herb or spice-containing composition's water activity to below a level where microbial spoilage will be prevented. However, in addition to such high amounts of salt being likely to adversely affect the taste of the resultant composition, such an amount of salt is an order of magnitude greater than that recommended by some health authorities. The inclusion of water activity controllers may also preclude a composition being able to claim organic status.

In the food compositions of the present invention, the plant material ideally has a water activity similar to that of the fresh plant material. As such, whilst compositions in accordance with the present invention might be prone to spoilage if stored at relatively high temperatures, they are typically intended to be stored below 0° C. (e.g. in a freezer), at which temperatures growth of spoilage organisms does not occur, or at a temperature of between about 4 to 8° C. (e.g. in a refrigerator) where the composition has been processed under hyperbaric conditions. The inventors believe that any potential disadvantages of having to store the composition in a frozen (or semi-frozen) state are far outweighed by the freshness and versatility of compositions in accordance with the present invention. As used herein, the phrase “spoilage organisms” is to be understood to mean the types of microorganisms which typically cause food spoilage, including yeasts, moulds and bacteria, and which are capable of growing at ambient temperatures. Some spoilage organisms are also pathogenic and can also include viruses and other microbes.

To the best of the inventors' knowledge, there exists no ready to use frozen or chilled storage stable food compositions that contain fresh plant material(s), such as fresh herb(s) and/or spice(s), which impart effectively the same organoleptic, nutritional and physical (e.g. textural) properties to the composition as would the fresh plant material(s), which do not need to be rehydrated or diluted, which do not require the use of acidulants, sugars, humectants or relatively high amounts of salts for stability and, importantly, which will not turn brown (even when heated) nor cause browning when mixed with foods containing phenolic compounds and other browning substrates.

Features of the present invention will be described in further detail below.

The present invention relates to ready to use storage stable food compositions and to methods for preparing ready to use storage stable food compositions. In specific embodiments, which will be described in further detail below, the invention relates to ready to use frozen seasoning compositions and to methods for preparing ready to use frozen seasoning compositions. The food composition includes at least a plant material (e.g. a herb, spice, fruit or vegetable) and an oil, but may also include any other edible component(s) or ingredient(s) which are not detrimental to the composition and which may might impart advantageous properties (e.g. an enhanced taste or improved scoopability), some of which are described herein. The composition may be provided in any ready to use (and storage stable) form, depending on factors such as the nature and relative proportions of its components and its intended use. For example, as discussed in more detail below, in some embodiments, the proportion and type of oil in the composition will enable it to be scoopable (e.g. using an ice cream scoop), even when used directly from a freezer after being stored at temperatures as low as −20° C. As would be appreciated, this enables individual portions of a frozen food composition to be easily obtained and dispensed from bulk. The semi-solid nature of such a composition ex- the freezer also enables it to be easily incorporated into other foods, for example for coating hot pasta, rice etc.

The ready to use storage stable food composition of the present invention includes a fresh plant material. Any plant material, or combination of plant material(s), may be used in the present invention. Typically, however, the plant material used in the present invention would be one (or more) that would usually be susceptible to spoilage upon activation of enzymes such as those described herein, and especially browning enzymes like PPO. As noted above, in the present invention, despite having been comminuted, mixed with other components and heated, the plant material in the food composition retains a vast majority of the organoleptic properties and natural components of the original fresh plant material.

In some embodiments, the plant material may be a herb, a spice, a fruit or a vegetable. In some embodiments, the plant material may comprise a combination of two or more plant materials. In some embodiments, the vegetable is selected from broccoli, spinach, kale, rocket (or other green leafy vegetables), green tea and combinations thereof. In some embodiments, the fruit is selected from avocado, eggplant, banana, mango (or other fruits susceptible to PPO browning) and combinations thereof. In some embodiments, the herb or spice is selected from basil, oregano, sage, marjoram, thyme, rosemary, mint, ginger, garlic, chilli, green peppercorns, coriander and combinations thereof.

The amount of the plant material in the composition of the present invention depends on a number of factors, including the nature of the composition (and its other ingredients), the desired intensity of flavour and colour required, the desired textural properties and whether the composition is in the form of a concentrate. In light of the teachings contained herein, it is within the ability of a person skilled in the art to determine an appropriate amount of specific plant material(s) for any particular composition.

In some embodiments, for example, the composition may comprise between about 5 and about 90 wt % of the fresh plant material, between about 5 and about 80 wt % of the fresh plant material, between about 5 and about 75 wt % of the fresh plant material, for example, between about 20 and about 75 wt % of the fresh plant material, between about 30 and about 65 wt % of the fresh plant material, between about 40 and about 55 wt % of the fresh plant material, or between about 40 and about 75 wt % of the fresh plant material. In some embodiments, for example, the composition may comprise about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt % or about 90 wt % fresh plant material.

The ready to use storage stable food composition of the present invention also includes an oil. Any edible oil or combination of edible oils may be used in the present invention, and careful selection of an oil and an amount of the oil for use in the present invention can enhance the resultant composition. The oil may, for example, impart beneficial properties to the composition such as being efficient at retaining the prized flavours or aromas which might otherwise have been lost by the plant material (especially for herbs or spices) during comminution and heating. Furthermore, if enough oil is present during comminution, then the oil may prevent oxygen from interacting with the comminuted plant material, making the addition of an antioxidant and/or use of an anoxic processing environment less necessary or even potentially unnecessary. The oil may also enable rapid transfer of heat applied to the composition to the plant material contained therein in order to more rapidly deactivate its browning enzymes. The oil may also impart a desirable texture to a resultant frozen composition (e.g. a semi-solid, scoopable texture).

The oil may also, for example, be selected for its characteristic stability, taste, colour, smoke point, health benefits or its viscosity and tendency to crystallise at a certain temperature (e.g. when stored in a freezer or refrigerator). Other factors which may influence the selection of an oil include its degree of saturation (primarily for health and viscosity reasons) and its cost.

In some embodiments, the oil is a vegetable oil. For example, the oil may be selected from the group consisting of: olive oil, peanut oil, sesame oil, canola oil, sunflower oil, safflower oil, cottonseed oil, corn oil, palm oil, rice bran oil, coconut oil and combinations thereof.

As used herein, the term “oil” is intended to include other suitable edible lipids, including suitable fats (which are solid at room temperature), either on their own or in combination (e.g. blended) with an oil. In some embodiments, for example, the oil may comprise an animal fat (preferably one with a bland taste). For example, bland animal fats such as lard, duck fat, butter, ghee, etc. can be used, although their solid form at room temperature and relatively hard texture at freezer temperatures might mitigate against their use at high levels. Such fats, if used, might therefore need to be admixed with other oils to soften their viscosity, or could be gently heated and melted in order to aid incorporation into the admixture.

The amount of oil(s) (or lipid(s)) in the admixture or food composition depends on a number of factors, including the nature of the composition (and its other ingredients), the desired intensity of flavour, colour and textural properties (etc.), the heat stability of the oil(s) and the desired handling properties of the composition (e.g. when frozen). As noted above, for example, increasing the proportion of oil in the composition will lessen the ability of oxygen to interact with the plant material and provide more of an ingredient into which any flavour or aromatic components driven out of the plant material during heating may be entrained. In light of the teachings contained herein, it is within the ability of a person skilled in the art to determine an appropriate oil and an appropriate amount thereof for use in any particular composition.

In the method of the present invention, the oil is typically added to the admixture after all of the other ingredients have been added. Adding the oil at this stage means that it drips over the bulk ingredients and coats the plant material etc. more efficiently. As the next step is comminution, the oil is therefore more likely to be evenly mixed right from the start, rather than initially sitting at the bottom of a comminution vessel.

The amount of the oil in the admixture will typically be the same as that in the resultant ready to use food composition, although it may be desirable in some embodiments to add some more oil post-comminution.

In some embodiments, for example, the composition may comprise between about 10 and 95 wt %, between about 10 and 12 wt %, between about 12 and 30 wt %, between about 25 and 55 wt %, between about 20 and 45 wt % of the oil, between about 30 and 75 wt % of the oil, between about 50 and 85 wt % of the oil or between about 60 and 95 wt % of the oil. In some embodiments, for example, the composition may comprise about 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt % or 95 wt % oil.

Once admixed, the fresh plant material(s), oil and anything else in the admixture (as described herein) are comminuted at a substantially neutral pH and under conditions whereby browning enzymes in the plant material are substantially prevented from reacting (i.e. with the plant material or with other components of the admixture). As noted above, this immediate inhibition of enzyme activity substantially prevents the formation of browning products and associated intermediates, with their attendant problems. In the present invention, any browning reactions that may occur during comminution are so minor that they cannot be detected by a person, either visually or by tasting.

During comminution, the components of the admixture are intimately mixed and the fresh plant material (at least) would typically be chopped up into smaller pieces (although this may not occur for relatively small herbs or spices, for example thyme, whose leaves may already be an appropriate size for the composition) having a size appropriate for the resultant composition. Post-comminution, the herb or spice (and other components) will have a particle size consistent with the intended end use of the plant material-containing food composition. For example, if the composition was a puree, the particle size of the plant material would be relatively small. However, if the composition was a pesto, for example, where a more particulate mouthfeel is expected, the herb or spice pieces would be relatively large (and certainly larger than that of the puree).

Post-comminution (and in the comminuted mixture of fresh plant material and oil in the compositions of the present invention), the oil forms an intimate mixture with the plant material (and other components in the admixture) which, as described above, can further hinder oxygen from deleteriously interacting with the admixture. The post-comminuted admixture is in the form of a slurry, with the particulate components of the slurry being substantially homogeneously dispersed and its viscosity being dependent primarily on the amount and type of oil in the admixture. If the slurry contains relatively higher amounts of particulates and lower amounts of oil it will be paste-like. If the slurry contains relatively lower amounts of particulates and higher amounts of oil it will be semi-liquid in form.

Any technique which results in a suspension-like admixture of the plant material, oil, etc. may be used to comminute the admixture in the method of the present invention. Typically, a reduction in the particle size of at least the plant material will occur but, as noted above, this will depend on the size of the plant material added to the admixture (e.g. its leaf size) and the intended end use of the composition. Thus, it is not essential for comminution to involve the physical cutting or shredding of the plant material. Indeed, it may be beneficial in some circumstances to use a more gentle blending methodology or system to comminute the admixture, which does not necessarily involve a reduction in the particle size of the plant material (but which does cause the plant material to become evenly dispersed throughout the oil matrix).

Any comminuting method known in the art may be used, provided that the components in the admixture become thoroughly mixed and enzymes in the comminuted plant material are substantially prevented from causing browning by reacting with phenolic compounds in the plant material or in any other component in the composition.

As will be discussed in further detail below, the comminuting may be carried out either prior to or concomitant with the heating step.

Suitable comminuters include hand-held commercial electric choppers with a blade attachment (e.g. under laboratory conditions or on a pilot scale), an industrial bowl chopper, optionally vacuumised or under a nitrogen atmosphere, or an industrial heating-whilst-chopping all-in-one chopping bowl (e.g. Bowl Cutters available from Maschinenfabrik Seydelmann KG Germany).

In the comminuted mixture of fresh plant material and oil in the compositions of the present invention, the plant material (and, optionally, other components) similarly has a particle size consistent with the intended end use of the food composition, with the plant material (etc.) being intimately mixed with and evenly dispersed throughout the oil, as discussed above in the context of the method of the present invention.

In the present invention, the admixture of fresh plant material(s) and an oil are comminuted at a substantially neutral pH and the ready to use storage stable food composition has a substantially neutral pH. As described above, in conventional herb/spice preservation methods, an acidulant is often used to inhibit enzyme activity and/or limit microbial activity, notwithstanding that acidic conditions can be detrimental to the organoleptic properties of the herb/spice. In the present invention, however, the composition maintains a substantially neutral pH, which the inventors have found does not perceptibly affect the organoleptic properties or colour of the plant material, even with more delicate herbs or spices.

In some embodiments, the admixture may itself have a substantially neutral pH, in which case no further action is necessary. In other embodiments, however, the admixture may not have a substantially neutral pH, and the organoleptic properties and colour of the resultant composition might suffer during comminution (and heating). In such embodiments, a pH adjusting agent is required to prevent the pH moving away from being substantially neutral (e.g. as may be caused by any ingredient in the composition).

Typically, ingredients in the composition would be more likely to cause the pH to become acidic (e.g. below about 6.5) and a pH adjusting agent in the form of a pH raising agent will be required. If the composition becomes too acidic, browning of the green chlorophyll in the plant material may occur, and an acidic taste imparted to the composition. For example, pesto recipes typically include Parmesan cheese which, when comminuted with basil and oil, could make the composition slightly acidic. In embodiments where the composition is a pesto, it may therefore be necessary to use a pH raising agent to maintain the substantially neutral pH. Alternatively, one of the antioxidants which may be used in the present invention (as will be described below) is ascorbic acid (especially if organic certification is desired). However, adding ascorbic acid to protect the comminuted herb or spice from oxygen may cause the pH of the composition to drop too much, and it would therefore be necessary to use a pH raising agent, lest the low pH deleteriously affect the composition during processing or storage. Other potentially acidic ingredients (which would need to be added in small amounts so as to not over acidulate the composition but which may improve the composition's flavour or consistency) may include wine, fruit juice, tomatoes, etc.

Suitable pH raising agents include, for example, sodium or potassium bicarbonate, sodium or potassium hydroxide, sodium ascorbate, sodium erythorbate, disodium hydrogen phosphate. In some circumstances, a combination of pH raising agents might be used.

Although less likely, other ingredients in the composition may cause its pH to rise above about 8, thus necessitating the use of a pH reducing agent to reduce the pH of the comminuted admixture (and resultant composition) such that it is substantially neutral. If the composition becomes too alkaline (i.e. above a pH of about 7.5 or 8, depending on the plant material), the texture of the plant material may be adversely affected (typically by softening, although a soapy mouthfeel may also occur). In such a case, the use of ascorbic acid as an antioxidant would also act to reduce the pH. Other pH reducing agents which might be used include, for example, citric acid, erythorbic acid, vinegar and lactic acid. In some circumstances, a combination of pH reducing agents might be used.

In some embodiments, the pH adjusting agent may provide a buffering effect. For example, if sodium hydrogen carbonate was used as a pH raising agent to raise the pH of the composition, it may also act as a buffer to maintain the pH at around neutral.

When used, the pH adjusting agent may be added to the admixture at any suitable time during the method for preparing the ready to use storage stable food composition. Typically, the pH adjusting agent may, for example, be added (along with the other components) to the admixture before comminution, where its pH adjusting properties will be available immediately upon comminution.

The amount (if any) of the pH adjusting agent added to the composition depends on a number of factors, including the nature of the composition and its other ingredients. In light of the teachings contained herein, it is within the ability of a person skilled in the art to determine whether a pH adjusting agent is required for any particular composition and, if so, which agent to use and in what amount.

In some embodiments, for example, the composition may comprise between 0 and about 5 wt %, between 0 and about 2.5 wt %, between 0.25 and about 1.5 wt % or between 0.5 and about 1.0 wt % of the pH adjusting agent. In some embodiments, for example, the composition may comprise about 0.5 wt %, about 1.0 wt %, about 1.5 wt %, about 2.0 wt %, about 2.5 wt %, about 3.0 wt %, about 3.5 wt %, about 4.0 wt %, about 4.5 wt % or about 5 wt % pH adjusting agent.

As would be appreciated, the amount of the pH adjusting agent in a composition of the present invention (e.g. post-preparation) may well be less than that originally added, as it will react in order to make (or maintain) the pH of the composition substantially neutral.

The admixture of the fresh plant material and oil (along with any other components in the admixture) are comminuted under conditions whereby browning enzymes in the plant material are substantially prevented from reacting with the plant material and any other components in the admixture.

As noted above, browning enzymes in the plant material typically become more active once the plant material has been comminuted, and especially so as the comminuted mixture starts to be heated. It is therefore important that their activity be inhibited before they are ultimately inactivated by heating.

Browning enzymes require oxygen before they are able to cause browning by reacting with phenolic compounds in the plant material or other food. Accordingly, in some embodiments, substantially preventing the browning enzymes from reacting may involve preventing oxygen from interacting with the plant material. Any method via which oxygen can be prevented from interacting with the plant material (and especially after the plant material is cut or bruised during comminution or mixing and in the early stages of heating) before the enzymes are permanently inactivated during the heating step may be used in the present invention to prevent the browning enzymes from reacting.

In some embodiments, comminution may occur under anoxic conditions. In some embodiments, the comminuting and heating steps may be carried out in a vacuum or under a nitrogen (or other non-reactive gas) environment. In some embodiments, the comminuting and heating steps may be carried out in the presence of oxygen inhibitors such as an antioxidant or vitamin E (tocopherols), which protect the composition from free radicals and peroxide-containing species, which are products of oxidative enzyme activity.

In some embodiments, the type and/or proportion of oil in the admixture may be sufficient to substantially prevent browning enzymes in the plant material from reacting. In such embodiments, the oil effectively forms a physical barrier around the plant material during comminution and heating, thus preventing oxygen from being able to interact with the bruised/cut plant material, for at least as long as it takes the comminuted mixture to be heated.

In some embodiments, an edible antioxidant may be added to the admixture before comminution. Incorporation of such an antioxidant into an intimate mixture with the comminuted plant material substantially prevents oxygen from being able to react with, and hence activate, the browning enzymes, and especially so in the early heating stages of the admixture, where the browning enzymes become more active but are not yet permanently inactivated by the heating step. When used, suitable antioxidants may include sodium erythorbate, sodium ascorbate, vitamin E or a mixture thereof.

The amount (if any) of the antioxidant added to the composition depends on a number of factors, including the proportion and type(s) of plant material in the composition, the relative activity of the browning enzyme system in the plant material, the other ingredients in the composition (especially the amount of oil in the composition), whether an organic certification is required, the batch size to be processed, whether nitrogen or a vacuum is used during comminution, as well as the temperature and method of heating used. In light of the teachings contained herein, it is within the ability of a person skilled in the art to determine whether an antioxidant is required for any particular composition and, if so, which antioxidant and in what amount.

In some embodiments, for example, the composition may comprise between 0 and about 5 wt %, between 0 and about 2.5 wt %, between 0.25 and about 1.5 wt % or between 0.5 and about 1.0 wt % of an antioxidant. In some embodiments, for example, the composition may comprise about 0.5 wt %, about 1.0 wt %, about 1.5 wt %, about 2.0 wt %, about 2.5 wt %, about 3.0 wt %, about 3.5 wt %, about 4.0 wt %, about 4.5 wt % or about 5 wt % antioxidant.

Whilst, under industrial conditions, the method can readily be carried out in a vacuum or under a nitrogen environment (e.g. in a bowl chopper), use of an oxygen inhibitor or antioxidant may still be prudent as a safety measure in case of possible exposure to oxygen.

The ready to use storage stable food composition of the present invention may also beneficially include other components, where those components are not detrimental to the properties of the composition.

In some embodiments, for example, one or more other foods (i.e. in addition to the oil and plant material) may be included in order to impart a desirable flavour, colour or texture to the resultant plant material containing food composition. The one or more other foods may, for example, be supplementary seasonings or garnishes and the like, including those selected from the group consisting of pine nuts, peanuts, walnuts and other nuts, cheeses such as Parmesan cheese, avocado, dairy and non-dairy powders, non-animal powders, juices and combinations thereof. As described above, the one or more other foods may also, for example, be fruits and vegetables less susceptible to browning enzyme activity. For example, fruits/vegetables such as sun dried tomatoes, goji berries, raisins, lemon zest, etc., may be provided as garnishes. For example, fruits/vegetables such as chilli and capsicum are not overly susceptible to browning or heat, and hence require a less comprehensive protection against browning enzyme activity than other plant materials.

When present, such other foods may be added at any suitable stage during preparation of the ready to use storage stable food composition. Typically, the other foods would be added to the admixture before comminution in order to ensure that they were thoroughly mixed throughout the composition. However, one or more of the other foods may be added at a later stage (or stages), for example, if they do not require (or would be damaged by) comminution or if they are sensitive to heat.

The amount (if any) of such other foods added to the composition depends on a number of factors, including their appearance, physical nature or taste, whether they are acidic or alkaline, how stable they are to heat, as well as the nature of the composition and its other ingredients. In light of the teachings contained herein, it is within the ability of a person skilled in the art to determine what amount of any such other foods should be included in any particular composition.

In some embodiments, for example, the composition may comprise between 0 and about 60 wt %, between about 0 and about 50 wt %, between about 10 and about 40 wt %, between about 20 and about 30 wt %, between 0 and about 25 wt %, between about 5 and 20 wt %, between about 10 and 15 wt %, between about 10 and 20 wt % or between about 15 and 25 wt % of these other foods. In some embodiments, for example, the composition may comprise about 3 wt %, 5 wt %, 7 wt %, 10 wt %, 13 wt %, 15 wt %, 17 wt %, 20 wt %, 23 wt %, 25 wt %, 27 wt %, 30 wt %, 33 wt %, 35 wt %, 37 wt %, 40 wt %, 43 wt %, 45 wt %, 47 wt %, 50 wt %, 53 wt %, 55 wt %, 57 wt % or 60 wt % of these other foods.

In some embodiments, a small amount of one or more other ingredients (i.e. in addition to the oil, plant material and, optionally, other foods) may be included in order to impart desirable properties to the resultant composition. For example, a relatively small amount of salt, dry black pepper or sugar may be added to enhance the flavour of the resultant composition. Small amounts of ingredients such as salt may also alter properties such as the melting point of the composition and hence affect factors such as its scoopability direct from the freezer, or its stability at slightly higher temperatures. In certain situations, it may also be beneficial to add other ingredients such as emulsifiers, stabilisers, flavours, colours, nutrients, water or other liquids, and the like, provided that any such other ingredients do not deleteriously affect the composition.

With the exception of water or other liquids, the total amount of any such other ingredients added to the composition should not exceed 1-5 wt %. For example, if too much salt was added, it may draw moisture out of the comminuted plant material in the composition and deleteriously affect its organoleptic properties. Up to about 10 wt % water and about 5 wt % other liquid may be added to the composition, either to enhance its flavour or maintain the weight of the composition for economic reasons, as discussed below.

In the present invention, the admixture (e.g. the comminuted mixture, if heating is carried out subsequently to comminution) is rapidly heated to a temperature at which the browning enzymes are substantially inactivated. The inventors have found that if the admixture is heated to a temperature effective to inactivate any browning enzymes in the plant material, then substantially all of the other enzymes which may cause undesirable effects will also be inactivated. Heating to the elevated temperature may also help to reduce the microbial load of the admixture and hence the resultant composition. As used herein, the phrase “substantially inactivated” is to be understood to mean that any amount of browning enzymes that might not be inactivated during heating is so small as to be incapable of affecting the taste or appearance of the plant material in the composition, even over extended storage periods.

The admixture may be rapidly heated in this manner using any suitable technique for rapid and controllable enzyme inactivation. For example, the admixture may be exposed to microwave radiation or a hot fluid (e.g. sealed in a fluid-tight vessel and immersed in hot water or an oil), or heated in a heat exchanger such as a scraped surface heat exchanger.

The admixture may be heated either concomitantly with or subsequent to the comminution, depending on factors such as the activity of the browning enzymes in the plant material and the availability of suitable processing equipment. Whilst more complicated equipment may be required to comminute and heat the admixture concomitantly, such equipment may be worthwhile if it results in a better product or one that can be more efficiently produced on an industrially relevant scale.

Typically, the heating step is carried out in a closed system (e.g. a tube-in-tube heat exchanger, a sealed bag or in a closed vessel (e.g. under N₂)) in order to ensure that no moisture is lost from the composition (and hence no weight loss or drying of the composition occurs).

The temperature to which the admixture is heated, the rate at which it is heated and the time at which it spends at an elevated temperature, will depend on the components of the composition (primarily the plant material) and, in light of the teachings contained herein, can be determined by a person skilled in the art, using routine experiments if necessary. The heating step is ideally very fast, only requiring the maximum (enzyme inactivating) temperature to be reached, possibly with a short holding time at that temperature to ensure complete inactivation. Such a rapid heating represents a significant energy (and hence cost) saving over other methods conventionally used to heat herb or spice-containing preparations (e.g. traditional pasteurisation processing of non-acidic foods requires vegetative microorganisms to be killed at this stage and hence requires heating to a minimum temperature of 63° C. for 30 minutes).

Once the heating step has been performed, the browning enzymes will have been substantially inactivated, and this can be confirmed in trials, for example by using many known techniques, the simplest of which is to leave a small sample of the composition (post-heating) at ambient temperature in air and see whether it turns brown. Alternatively, a chemical assay check for enzyme activity can be performed using, for example, colour development with H₂O₂/guaiacol reaction (as is described in Food Analysis 3^{rd} Ed 2003. S. S. Nielsen part 16.3.2.1).

If the comminution and heating are separate steps, the comminuted mixture should be rapidly heated as soon as possible in order to inactivate the (inhibited) browning enzymes as quickly as possible (and noting that the browning enzymes will likely become more active as the temperature starts to rise) because browning reactions typically occur more quickly in physically damaged plant material. A rapid rate of heating will also minimise evaporation of moisture in the composition. However, the inventors have surprisingly found that short delays may be acceptable, for example if further ingredients are to be added post-comminution (and especially so if the plant material is well protected, e.g. by the oil and possibly an antioxidant). This may be advantageous in industrial-scale processes, where large volumes of comminuted materials may face delays between comminution and heating, giving great utility to the process in practical terms not possible before.

Many of the browning enzymes will start to be inactivated above a temperature of about 60° C. due to protein denaturation. However, inactivation will only occur relatively slowly at this temperature, so it would usually be beneficial to heat the admixture to a temperature greater than this (as long as this will not deleteriously affect the composition). The maximum temperature should not exceed about 95° C., however, since this may lead to loss of volatile flavours as well as textural losses and deleterious chemical changes in the plant material, especially for delicate herbs or spices. In some embodiments, for example, the admixture may be rapidly heated to a temperature of between about 75° C. to about 90° C., between about 80° C. to about 90° C. or between about 80° C. to about 95° C. In some embodiments, for example, the admixture may be rapidly heated to a temperature of about 75° C., about 80° C., about 85° C. or about 90° C.

The length of time for which the admixture remains at (or around) the maximum temperature will depend on factors such as the maximum temperature, the type of plant material, its physical form and the type of browning enzymes. For many plant materials, heating to this temperature for a time of in excess of about 30 seconds is sufficient to inactivate substantially all browning enzymes in the plant material. In some embodiments, for example, the admixture remains at (or around) its maximum temperature for a time of between about 30 seconds and about 2 minutes, between about 45 seconds and about 1.5 minutes, between about 1 minute and about 1.5 minutes or between about 1.5 seconds and about 2 minutes. In some embodiments, for example, the admixture remains at (or around) its maximum temperature for about 30 seconds, about 45 seconds, about 60 seconds, about 75 seconds, about 90 seconds, about 105 seconds or about 120 seconds.

In some embodiments, for example where the composition is a basil pesto, the comminuted mixture may be rapidly heated to a temperature of between about 80° C. to about 90° C. for a time of between about 30 seconds and about 2 minutes. The inventors have found that a temperature of about 85° C. is an appropriate inactivation temperature for a majority of browning enzymes in basil (as well as other herbs and spices).

As discussed above, the admixture is rapidly heated to the temperature at which the browning enzymes are substantially inactivated. The rapid heating regimen may vary, depending on the quantity and nature of the admixture (primarily the plant material and amount of oil present) and, in light of the teachings contained herein, a person skilled in the art could readily establish the most appropriate temperature and time for any particular composition of admixture. The admixture may, for example, be heated to this temperature within about 1 to about 3 minutes (e.g. about 1 to about 2 minutes or 1 minute or less, for example, about 30 seconds or about 45 seconds to about 1 minute). The heating rate may, for example, be between about 0.1° C./sec to about 1° C./sec, between about 0.3° C./sec to about 0.8° C./sec, between about 0.4° C./sec to about 0.6° C./sec, between about 0.3° C./sec to about 0.7° C./sec for 100 g of the admixture. The heating rate may, for example, be about 0.1° C./sec, about 0.2° C./sec, about 0.3° C./sec, about 0.4° C./sec, about 0.5° C./sec, about 0.6° C./sec, about 0.7° C./sec, about 0.8° C./sec, about 0.9° C./sec or about 1.0° C./sec for 100 g of the admixture.

As described herein, other factors can be used to increase the efficiency of the rate at which the plant material in the admixture is heated. For example, an oil that efficiently transfers applied heat to the plant material etc. may be used in the composition. The admixture may also be de-aerated prior to heating or agitated during heating in order to increase the heating efficiency. Further, use of efficient heat exchangers (e.g. having large surface areas which transfer heat, such as concentric tube heat exchangers) to effect rapid heating of the plant material is envisaged for large scale operations.

During heating, the composition loses substantially no weight. As such, substantially no moisture or volatile components of the plant material escape from the composition and substantially no drying of the plant material occurs. This is especially important for herbs and spices, due to their delicate flavour and aroma components. In this manner, the plant material remains in the composition in an as close to a fresh state as possible, retaining its prized nutritional value as well as its volatile flavour and aroma components. Further, there is no need for the plant material to rehydrate when used in cooking which, as described above, can sometimes be a problem with dried or partially dried herbs or spices.

Any suitable technique may be used to ensure that the composition loses substantially no weight during heating. For example, the admixture may be heated in a closed system (e.g. a tube-in-tube heat exchanger) or in a substantially sealed container, with any steam produced during the heating process being prevented from escaping. In embodiments containing a relatively large proportion of oil, any moisture or volatile components in the plant material may well simply not be able to escape due to the plant material having a thick coating of oil. Even if a small weight loss (e.g. less than about 5 wt % of the total composition) should occur, however, this will not affect the performance of the invention (although it is preferable that no weight loss should occur for economic reasons). However, if the heating process utilised is such that a slight weight loss occurs, this weight loss may be compensated for by adding water to the composition (either before or after heating) in an amount substantially the same as that expected to be lost during heating.

The water activity of the plant material in the composition does not change significantly during processing. The water activity of fresh herbs such as basil is about 0.98 and for more woody herbs like rosemary it is about 0.94. In the present invention it is preferable that the water activity of the composition is between about 0.91 and about 0.97. A water activity of lower than about 0.91 will mean that the plant material will have lost too much of its fresh characteristics, and a water activity of above about 0.98 may cause problems with moisture transfer between ingredients in the composition or the composition and other foods with which it is mixed. In some embodiments, the water activity of the composition is between about 0.91 and about 0.97, between about 0.92 and about 0.96, between about 0.93 and about 0.95, between about 0.94 and about 0.96, between about 0.95 and about 0.97. In some embodiments, the water activity of the composition is about 0.91, about 0.92, about 0.93, about 0.94, about 0.95, about 0.96, about 0.97 or about 0.98.

Once heated to the temperature at which the browning enzymes are substantially inactivated (and for a time sufficient to achieve this), the heated mixture is cooled to a temperature at which growth of spoilage organisms does not occur. The cooling may occur at any suitable rate (noting that the plant material should only be exposed to high temperatures for as short a period as possible) and would primarily be governed by the storage conditions of the mixture post-heating. In some embodiments, for example, the mixture may be rapidly cooled after the heating step, for example using a heat exchanger (possibly even the same heat exchanger in which the admixture was heated), to ambient temperatures or lower, and then placed in a freezer. The cooled bulk mixture may be packaged directly into consumer or food service packs or bulk packed before further storage in the freezer or chilled. Alternatively, the mixture may be placed directly into a freezer after the heating. In some embodiments, cooling the heated admixture to a temperature at which growth of spoilage organisms does not occur comprises freezing the heated admixture.

The admixture may be cooled to any temperature at which spoilage organisms will not grow. In effect, spoilage organisms such as microbes will not grow below about 0° C. Hence, the present invention may involve cooling the composition to a temperature below 0° C., for example between about −10 and about −20° C. (i.e. that found in commercial and domestic freezers). It is envisaged that the composition can be stored in the freezer for a significant length of time (e.g. at least two years in a domestic freezer), with individual aliquots being removed when needed.

In some embodiments, if desired, the composition (or a portion of the composition) may be removed from the freezer (for example) and subsequently stored under non-frozen conditions (e.g. at about 4° C.) in a refrigerator for up to about a week. Once above about 0° C., however, spoilage organisms can begin to grow and the composition's shelf life is shortened. Embodiments of the composition containing small amounts of salt may, for example, be more resistant to growth of spoilage organisms when stored at temperatures commonly found in refrigerators. Longer shelf life at refrigerator temperatures may also be achieved using hyperbaric processing, as described below.

In some embodiments, a useful shelf-life at refrigeration temperatures might also be achieved if the composition ex- the freezer was subsequently stored under anoxic conditions, for example, under a nitrogen environment. Storing under such conditions would stop yeasts and moulds, in particular, from growing.

As noted above, the post-heated admixture may be immediately placed into a freezer in order to cool it down to a temperature of between about −10 and about −20° C. In other embodiments, however, the post-heated mixture may be kept at an ambient temperature for a period of time (e.g. so that it can more easily be transferred into a container). Alternately the post-heated admixture can be cooled to an intermediate temperature (e.g. between 5-30° C.), packed in suitable storage containers and then stored in the freezer. Such versatility would be advantageous for scaled up industrial operations because many conventional preservation methods need to be kept under strict sterile conditions once heated.

Depending on the amount (and, to a lesser extent, the type) of oil, the resultant composition may have a frozen or semi-frozen consistency when removed from a freezer. A semi-frozen consistency may enable the composition to be scoopable ex- the freezer, much like ice cream, and hence very easily dispensable. Alternatively, a semi-frozen consistency may enable the composition to be pumpable ex- the freezer, using conventional pumping apparatus fount in kitchens. Compositions having relatively lower amounts of oil may benefit from being stored at slightly higher temperatures (although not so high that spoilage organisms might start to grow).

Although the plant material remains in a substantially fresh form in the composition, and hence retains much of its water content and cellular structure, the inventors have found that frozen storage does not adversely affect the plant material. Even though some minor cellular damage may occur when the composition is thawed for use in cooking, surprisingly, the texture of the composition is very close to that of a freshly comminuted/unheated composition. In addition, no browning or discolouration occurs because there are no active browning enzymes (in contrast, thawing many conventional frozen herb or spice compositions containing inhibited enzymes usually results in very quick browning due to the re-activated enzymes very rapidly reacting with the damaged thawed herbs or spices and/or with other foods). Surprisingly, the inventors have also found that frozen compositions of the present invention can withstand multiple freeze-thaw cycles without the product quality being damaged. Also surprisingly, plant materials treated according to present invention can be brought to chilled or serving temperatures and will not brown, even when left in contact with air for hours. This provides cooks, chefs and food service operations with a significant advantage when compared to the traditionally labile versions of these foods products. The inventors, however, do not advise that the product be left at room temperature for an extended period of time (e.g. 60+ minutes) and refrozen, as spoilage organism activity could commence.

While the present invention typically involves storing the composition under freezer conditions (e.g. between about −10 and about −20° C.), a usefully long shelf-life of up to about 6 weeks (e.g. 1-2 weeks, 2-4 weeks or 4-6 weeks) under refrigeration (e.g. 4 to 8° C.) can be achieved by subjecting the finally packaged composition to hyperbaric processing. Hyperbaric processing is a technique where extreme pressure can be used to destroy pathogens and reduce the overall load of vegetative microbiological spoiling flora. As such, packaged portions of food compositions in accordance with the present invention could be hyperbarically processed such that they are storage stable, at least for a short time (e.g. 4-6 weeks), at temperatures commonly found in domestic refrigerators.

An overview of hyperbaric processing is provided in: High Pressure Processing of Food: Principles, Technology and Applications edited by V. M. Balasubramaniam, Gustavo V. Barbosa-Cänovas, Huub L. M. Lelieveld 2016. The products of the present invention have suitable characteristics for use in hyperbaric treatment for shelf life extension due to the water activity being above 0.91. Combining the fast, high volume, continuous heating operation of the present invention with the batch-wise hyperbaric processing operation can provide a synergistic outcome. This is because the former can be quickly processed and bulk stored safely, whilst retaining all the desired product qualities, for a long-term if frozen, while the latter can be utilised just prior to chilled distribution of the products.

In some embodiments, hyperbarically processing the food composition may comprise applying a pressure of between about 400 MPa and about 850 MPa (e.g. about 500 MPa and about 700 MPa, about 400 MPa and about 600 MPa, about 450 MPa and about 550 MPa, or about 500 MPa, about 520 MPa, about 540 MPa, about 560 MPa, about 580 MPa or about 600 MPa) to the composition. Such a pressure may be applied over any suitable time, for example from a few seconds to several minutes, (e.g. from about 1 to about 5 mins or 10 mins or even up to about 30 mins, if required). Low temperature high pressure treatment is preferred as the heating step already reduces the microbial load of the product.

The food composition of the present invention may be hyperbarically processed immediately after cooling and packaging in suitably sized portions, or may be stored (e.g. in a freezer) for a period of time beforehand (either pre-packaged, or packaged after being stored in the freezer). Typically, the frozen composition would be separated into smaller units before being hyperbarically processed, with those units being appropriately sealed in order to prevent subsequent microbial contamination.

In another aspect, the present invention provides a container comprising a plurality of servings of the ready to use storage stable food composition (e.g. a frozen seasoning composition or hyperbarically processed food composition). The plurality of servings of the composition may be provided in a single portion of the container, or may be separated into a number of smaller portions.

In some embodiments, for example, each of the plurality of servings may be provided in a distinct portion of the container. Each of these distinct portions may be separable from the remainder of the container, for example, by snapping a frangible portion of the container. Such containers are known in the art.

In other embodiments, the plurality of servings may be provided in bulk form in the container. The container may have a capacity of 1 L, 2 L, 4 L or even 10 L or greater (e.g. for use in busy Italian restaurants or industrial applications). Ideally, the composition would be in the form of a scoopable composition, with individual servings being scooped out as needed. Alternatively, a flexible pouch could be used with a dispenser nozzle and the pouch compressed to expel portions of the composition, thus avoiding air contact with the packaged composition or its potential contamination (e.g. with other foods). An alternative method of dispensing is to pump the composition from a receptacle at a required rate of delivery to the application.

In another aspect, the present invention provides a mixture comprising the storage stable food composition of the present invention and a food base (e.g. pasta, wheat noodles, rice, potato, sweet potato, pizzas, bread, stuffings, pancakes, cakes, scones, muffins, focaccia, etc.). Embodiments of this aspect include, for example, ready to eat frozen pesto pasta meals, where all a user needs to do to prepare a delicious and fresh tasting pesto pasta meal is to heat the packet containing the pre-mixed pesto composition of the present invention and pre-cooked pasta (e.g. in a microwave or a pouch in hot water). Such ready to eat, frozen meals are popular with many consumers.

Surprisingly, the inventors have found that the composition is stable to reheating (e.g. in a domestic radiant oven or a microwave oven) when used as an ingredient in recipes such as pre-coated pesto pasta, herb muffins, cakes and pizza toppings. For example, the inventors have found that a basil-containing frozen seasoning composition retained its natural bright green colour and pungent flavour and aromas during and after reheating. The inventors also tested the suitability of coated pasta and herb muffins for storage over extended periods (e.g. longer than about 1 year) in the freezer. These products were reheated for consumption (e.g. in a conventional oven or a microwave oven) after such storage, and were found to remain both bright green and retain their pungent fresh herb and spice aroma and taste. It was also noted that the pasta and muffin crumb portion had not (and did not) brown.

A more specific embodiment of the present invention will now be described.

In a specific embodiment of the method of present invention, an antioxidant and an edible oil (e.g. a vegetable oil) are admixed intimately with fresh herb(s) and/or spice(s) and maintained at a pH of 7 or marginally higher. Other ingredients may be mixed with the herb or spice or mixtures thereof, such as small amounts of salt or sugar, as well as supplementary seasonings or garnishes and the like. Other foods may also be mixed with the herb or spice or mixtures thereof, such as nuts, fruits and vegetables (as described above) and cheeses. A pH of around 7 may, for example, be achieved (if necessary) by use of a slightly alkaline antioxidant such as sodium ascorbate, a mixture of ascorbic acid and sodium or potassium bicarbonate or a combination of sodium ascorbate and sodium or potassium bicarbonate.

The admixture of ingredients is comminuted (e.g. chopped or pureed) to a required degree and then heated rapidly by any suitable means (e.g. by immersion of sealed packages in water at about 95° C., by microwave heating, by use of a scraped surface heat exchanger) for long enough to inactivate the PPO (etc.) contained in the herbs or spices. The comminution may be carried out under vacuum or in an inert atmosphere such as nitrogen, under which conditions an antioxidant may be unnecessary. However, use of an antioxidant is recommended as a safety measure in case of possible exposure to oxygen. The heating stage can also occur simultaneously with the comminution of the admixture.

During this heating essentially no weight is lost from the admixture. However if the heating process utilised is such that a slight weight loss occurs, this weight loss may be compensated for by adding the weight of water equal to the expected loss of water during the brief heating process to the admixture (either before or after comminution, or even after heating). However if a small weight loss should occur this will not affect the performance of the invention.

The thus processed composition is promptly cooled and packed in substantially moisture-proof and oxygen-proof unit sized packages for storage at freezer temperature, e.g. about −18° C.

The resultant frozen product may be used directly from the freezer. On removal from the freezer it may be scooped or sliced to provide the quantity required for immediate use. The balance of the preparation may be returned to the freezer, suitably protected in its package for future uses. Alternately, the preparation may be packaged in small portioned units for use in entirety. Thus, bulk size or multiple serves or single serve packs can be used.

Preparations of herbs or spices or mixtures thereof may be added to cooked rice, noodles, pasta, potatoes, sweet potatoes, on breads, pizzas, in bakery recipes for scones, cakes, pancakes, muffins, focaccias, in stuffings, etc. and other foods, without causing browning of the resultant food mixture—either the herb or spice preparation or the food with which it is mixed.

Specific advantages of food compositions in accordance with embodiments of the present invention (i.e. over existing herb or spice-containing seasoning compositions), include:
a. Plant materials in the compositions of the invention retain their natural colour, flavour and aromatic character and do not become brown during storage or after thawing or in use.
b. The compositions of the invention will not cause browning of foods containing phenolic compounds to which they are added, even when mixed intimately and when the food is hot.
c. The compositions of the invention are at a substantially neutral pH and thus avoid the negative aspects of acidulation, such as sharp taste and unnatural brownish colour.
d. The compositions of the invention are free from additives that are conventionally used to prevent microbial spoilage.
e. The compositions of the invention do not require the presence of salt (e.g. to control the water activity of the composition), which is advantageous for health reasons and for better retaining the fresh organoleptic qualities of the plant materials.
f. Plant materials in the compositions of the invention are not dehydrated and hence the weight yield of product from the method of preparation is substantially equal to the sum of the inputs. The water activity of the product is also near to that of the fresh herbs.
g. The compositions of the invention can be provided as a range of herb- and spice-based compositions (e.g. sauces, purees, and pestos), in which the herbs or spices can have varying degrees of comminution.
h. The frozen compositions of the invention may be readily scooped, pumped, dispensed, sliced or subdivided into smaller aliquots for convenience in use. The frozen aliquots melt and disperse rapidly when added to a food to be seasoned and hence are very convenient in use.
i. This invention allows commercialisation of high quality pesto manufacture as an alternative to its current preparation on an as-required basis by trained chefs or well-practised home cooks.
j. The products of the invention may be prepared to provide products of organic status (e.g. by using sodium ascorbate as an antioxidant and no other chemical additions).

A specific embodiment of the present invention will be described below in the context of a traditional and very popular sauce well known as “Pesto”.

One of the main ingredients of pesto is usually basil, which is an extremely popular herb but which also has a very powerful and active PPO system. Pestos are traditionally prepared in many different versions; from herbs or herb mixtures other than basil, or basil in combination with other herbs as well as other ingredients. Pestos typically have an intense and pungent flavour so that when coated on to foods such as warm pasta, rice, vegetables or meats they impart their aromatic and flavour qualities to the whole dish.

Traditionally, pesto needs to be made fresh, within an hour or so of serving, because of its tendency to brown very quickly in air and rapidly lose its fresh aromatic flavours. Such a pesto preparation could only be stored for about 1 day in a refrigerator. Traditional recipes provide a pesto which retains its greenish colour and an acceptable flavour for a short time by use, for example, of excess olive oil in the preparation. However this is not successful in preventing browning when the pesto is mixed with, for example, cooked pasta or with other foods naturally containing phenolic compounds. The observed browning occurs in the herb preparation and in the cooked food containing phenolic compounds and also imparts bitter off-flavours.

Pre-blanching of the fresh herbs is effective in inactivating their contained PPO. However, sadly, it is also very effective in rendering the herbs essentially flavourless and hence useless for preparation of an acceptable herb or spice flavoured sauce or pesto. In addition, since herbs are of delicate structure for the most part, blanching on an industrial scale is quite impracticable because the herbs become very limp and flaccid and impossible to handle.

Herb sauces and pestos are widely available in acidulated, pasteurised shelf-stable formats, but these products are of poor herb flavour and equally poor colour and appearance.

Frozen herb products including basil are available, but they have been found to still contain active PPO enzyme systems and hence a propensity to cause the aforementioned undesirable browning reactions with rice, pasta and the like. Also, when these frozen preparations thaw, the active PPO contained in the herbs quickly reacts with phenolic compounds in the herbs themselves due to the destructive effect of freezing on cell integrity. This results in browning and loss of green colour of the herbs or spices, as well as off-flavour development very quickly post-thawing. They are also high in microbial count and do not withstand freeze/thaw cycling, so cannot be re-frozen safely.

In contrast to the traditional methods of preparing pesto, the embodiment of the present invention described below results in a storage stable (in the freezer) pesto which retains substantially all of the organoleptic and physical properties of the basil (and other ingredients), but which will not cause browning of other foods due to the browning enzymes having been inactivated. Pestos in accordance with the embodiment described below have been found by the inventors to be storage stable for at least 24 months at −18° C.

The embodiment involves the use of an antioxidant, an edible oil (typically a vegetable oil) admixed intimately with fresh basil, pine nuts, garlic and Parmesan cheese and maintained at a substantially neutral pH (noting that Parmesan cheese would otherwise make the comminuted mixture slightly acidic). A pH of 6.5 or slightly higher (up to about 7.5) may be achieved by use of a slightly alkaline antioxidant such as sodium ascorbate, which may be produced by admixing ascorbic acid and sodium bicarbonate.

The mix of ingredients is chopped or pureed to a required degree and then heated rapidly by any suitable means (e.g. by immersion of sealed packages in water at about 95° C., by microwave heating, by use of a scraped surface heat exchanger) for long enough to inactivate the PPO contained in the basil.

During this heating essentially no weight is lost from the pesto. However if the heating process utilised is such that a slight weight loss occurs, this weight loss may be compensated for by addition to the formula of the weight of water equal to the expected loss of water during the brief heating process. Whilst a small weight loss will not affect the performance of the invention, it is preferable that no weight loss should occur, especially for economic reasons.

The thus processed pesto is promptly cooled and packed in substantially moisture-proof and oxygen-proof unit sized packages for storage at freezer temperature, e.g. about −18° C.

The resultant frozen pesto may be used directly from the freezer. On removal from the freezer it may be scooped or sliced to provide the quantity required for immediate use. The balance of the pesto may be then returned to the freezer, suitably protected in its package for future uses. Alternately, the pesto may be packaged in small units for use in entirety. Thus, bulk size or multiple serves or single serve packs can be used.

The pesto preparations may be added to cooked rice, noodles, pasta, on breads and also used as baking ingredients, as well as in other foods without causing browning of the resultant food mixture—either the pesto preparation or the food with which it is mixed.

### EXAMPLES

Examples of specific embodiments in accordance with the present invention will now be described.

### Example 1

The following example demonstrates the preparation of a basil pesto product from fresh basil leaves made using a method in accordance with an embodiment of the present invention.

| INGREDIENTS | grams |
|---|---|
| Basil | 50.0 |
| Parmesan Cheese | 6.0 |
| Pine nuts | 6.0 |
| Garlic finely sliced | 5.0 |
| Salt | 1.5 |
| Sodium Erythorbate | 1.0 |
| Sodium Bicarbonate | 0.5 |
| Olive oil | 30.0 |
| ƒ | 100 |

The cleaned and trimmed fresh basil leaves were placed into a non-reactive plastic beaker along with the grated Parmesan cheese, pine nuts and the sliced garlic. The salts were added to beaker, with the oil then being poured over the admixture so that it had the opportunity to coat all of the ingredients upon its addition. The admixture was then comminuted in air using a hand-held commercial electric chopper with blade attachment to form a puree.

The beaker was covered to reduce evaporation and placed in a domestic microwave oven at 1200 W and heated for 40 seconds and then at 360 W for a further 80 seconds. The product was cooled to about 30° C. and then sealed in a film pouch of low O₂ transmission excluding all air and frozen. The colour of the product was bright green, similar to that of the starting fresh basil leaves. The pH of the resultant pesto product was 7.15, the Aw was 0.927, and it had a weight yield of 100%.

When a portion of the pesto product was placed in a bowl exposed to air at room temperature for several hours, the colour remained the same with no evidence of browning. A fresh portion of the pesto product ex the freezer was used to coat freshly drained hot pasta. The pesto remained green and the pasta showed no browning, even several hours after preparation. When the pasta was washed clean of the pesto coating it was evident that the pasta strand had retained its white colour to the centre.

Ready meal servings of coated pasta were prepared by packing in film and stored in a domestic freezer. After 6 months, 1 year and 2.5 years storage, the packs were reheated to serving temperature. The pesto coating was bright green, had a pungent flavour and taste and the pasta showed no browning.

### Example 2

The following example demonstrates the problems associated with use of traditional basil pesto preparations.

| | 2(a) | 2(b) |
|---|---|---|
| INGREDIENTS | grams | grams |
| Basil | 50.0 | 50.0 |
| Parmesan Cheese | 6.0 | 6.0 |
| Pine nuts | 6.0 | 6.0 |
| Garlic finely sliced | 5.0 | 5.0 |
| Salt | 1.5 | 1.5 |
| Pepper | 0.2 | 0.2 |
| Olive oil | 31.3 | 31.3 |
| ƒ | 100 | 100 |

In example 2(a), the cleaned and trimmed basil leaves were placed into a plastic beaker along with the pine nuts, grated Parmesan cheese and the sliced garlic. The other ingredients and then the oil were added to beaker, and the resultant admixture comminuted in air using a hand-held commercial electric chopper with blade attachment to form a puree.

In example 2(b), the same addition of ingredients was followed, but comminution occurred in the substantial absence of oxygen by directing a flow of nitrogen gas over the admixture.

The product from example 2(a) was sealed in a film pouch of low O₂ transmission excluding all air and directly frozen without any heating step. Product 2(b) was sealed in a film pouch of low O₂ transmission excluding all air and then heated to 85° C. for 2 minutes in a hot water bath and then finally frozen. The frozen samples were then compared. The colour of product 2(a) was green in the bulk, but with some browning at the edges of the pack, whilst product 2(b) had no browning.

When a portion of the frozen products 2(a) and 2(b) were placed in a bowl exposed to air at room temperature for several minutes, the colour of product 2(a) began to become olive green to brown on the surface, the depth of this discolouration increasing with time to black. A fresh portion of product 2(a) ex the freezer was used to coat freshly drained hot pasta and the pesto darkened very quickly to a black/olive colour, whilst the pasta darkened as well. When the pasta was washed clean of the pesto coating it was evident that the pasta strand had become brown. However, product 2(b) showed no browning on exposure to air, nor did it brown the pasta. Instead, the pesto remained bright green, even after 2 hours. Product 2(b) is therefore an example of an embodiment of the present invention in which use of an antioxidant is not required.

### Example 3

The following example demonstrates the use of the frozen basil pesto products of Example 2 in bakery applications for the preparation of herb muffins.

| | 2(a) | 2(b) |
|---|---|---|
| INGREDIENTS | grams | grams |
| Basil Pesto (example 2(a)) | 10.0 | 0 |
| Basil Pesto (example 2(b)) | 0 | 10.0 |
| Self-raising flour | 36.7 | 36.7 |
| Baking Powder | 0.3 | 0.3 |
| Melted margarine | 12.0 | 12.0 |
| Whole milk | 29.0 | 29.0 |
| Whole Egg | 8.0 | 8.0 |
| Parmesan cheese, grated | 4.0 | 4.0 |
| ƒ | 100 | 100 |

Basil Pestos prepared according to Examples 2(a) (i.e. not of the present invention) and 2(b) (i.e. of the present invention) were removed from the freezer and added to the combined other dry ingredients in a bowl and combined with the wet ingredients without over mixing. About 70 gram portions were placed in a lined muffin time and baked at 180° C. for 25 minutes in a pre-heated domestic oven.

For the pesto of Example 2(a), the resultant muffin crusts were dark brown and the exposed surface pesto portion dark brown and the crumb had browned. It had a hay like flavour and was somewhat bitter. For the pesto of Example 2(b), the resultant muffin crusts were golden light brown and the exposed surface pesto pieces were bright green and the crumb was bright green where the pesto had been blended and white where it had not. It had a strong pungent basil flavour and aroma and was not bitter at all.

These muffins were packed in film and stored in the freezer for 1 year, after which they were reheated in a domestic oven to thaw and warm through to about 60° C. They remained bright green and retained their strong basil flavour and aroma. The muffin crumb did not show any browning on storage or reheating.

### Example 4

The following example demonstrates the preparation of a mixed herbs pesto product from fresh thyme, marjoram, rosemary and sage leaves using a method in accordance with an embodiment of the present invention.

| INGREDIENTS | grams |
|---|---|
| Thyme | 15.0 |
| Marjoram | 15.0 |
| Rosemary | 5.0 |
| Sage | 15.0 |
| Parmesan Cheese | 6.0 |
| Pine nuts | 6.0 |
| Garlic finely sliced | 6.0 |
| Salt | 1.0 |
| Ascorbic Acid | 0.5 |
| Potassium Bicarbonate | 0.5 |
| Olive oil | 30.0 |
| ƒ | 100 |

The fresh trimmed herb leaves with only tender stems were prepared and, together with the other ingredients, treated as in Example 1. When the product was removed from the frozen pack its colour was bright dark green, similar to that of the starting fresh leaves. When the product was placed in a bowl exposed to air at room temperature for several hours, the colour remained the same with no evidence of browning. The aroma was very fresh and intense. A portion of cooked white rice was prepared and coated with the mixed herb pesto and the pesto stayed green, even after an hour in air. No browning of the rice was observed.

### Example 5

The following example demonstrates the preparation of a Thai herb pesto product from fresh coriander, basil, mint leaves with fresh ginger, chilli and garlic using a method in accordance with an embodiment of the present invention.

| INGREDIENTS | grams |
|---|---|
| Coriander | 15.0 |
| Thai Basil | 15.0 |
| Mint | 15.0 |
| Red Chilli | 5.0 |
| Fresh Ginger | 6.0 |
| Peanuts | 6.0 |
| Garlic finely sliced | 6.0 |
| Fish sauce | 1.0 |
| Ascorbic Acid | 0.5 |
| Sodium Bicarbonate | 0.5 |
| Peanut oil | 30.0 |
| ƒ | 100 |

The fresh trimmed herb leaves with only tender stems were prepared and the ginger, chilli and garlic was thinly sliced and, together with the other ingredients, treated as in Example 1. When the product was removed from the frozen pack its colour was bright dark green, similar to that of the starting fresh leaves. When the product was placed in a bowl exposed to air at room temperature for several hours, the colour remained the same with no evidence of browning. The aroma was very fresh and intense. A portion of cooked wheat noodles was prepared and coated with the mixed herb pesto and the pesto stayed bright green, even after an hour in air. No browning of the noodles was observed.

### Example 6

The following demonstrates the preparation of a basil and avocado pesto product from fresh basil leaves and fresh avocado flesh using a method in accordance with an embodiment of the present invention.

| INGREDIENTS | grams |
|---|---|
| Basil | 35.0 |
| Avocado | 15.0 |
| Pecorino Cheese | 6.0 |
| Green Chilli | 6.0 |
| Pine nuts | 6.0 |
| Garlic finely sliced | 6.0 |
| Salt | 1.0 |
| Sodium Ascorbate | 0.5 |
| Sodium Bicarbonate | 0.5 |
| Olive oil | 30.0 |
| ƒ | 100 |

The fresh trimmed basil leaves with only tender stems were prepared. Avocados were peeled, seeded and the flesh added to the basil leaves in a beaker. The chilli and garlic was thinly sliced and added to the basil and avocado. The resultant admixture with the remaining ingredients was treated as in Example 1.

When the product was removed from the frozen pack its colour was bright dark green, similar to that of the starting fresh leaves and avocado colour mix. When the product was placed in a bowl exposed to air at room temperature for several hours, the colour remained the same with no evidence of browning. The aroma was of very fresh chopped basil and was intense. A portion of cooked sweet potatoes was prepared and coated with the pesto and both the pesto and the sweet potatoes stayed bright green, even after an hour in air. No browning was observed in either the pesto coating or the sweet potatoes.

### Example 7

The following example demonstrates the preparation of a walnut, parsley and marjoram pesto product from fresh parsley and marjoram leaves using a method in accordance with an embodiment of the present invention.

| INGREDIENTS | grams |
|---|---|
| Parsley | 40.0 |
| Marjoram | 10 |
| Parmesan Cheese | 6.0 |
| Walnuts | 6.0 |
| Garlic finely sliced | 5.0 |
| Salt | 1.5 |
| Sodium Erythorbate | 1.0 |
| Sodium Bicarbonate | 0.5 |
| Olive oil | 30.0 |
| ƒ | 100 |

The cleaned and trimmed parsley and marjoram leaves and soft stems were placed into a plastic beaker along with the grated Parmesan cheese, shelled walnuts and the sliced garlic. The salts and remaining ingredients were added to the beaker and comminuted in air using a hand-held commercial electric chopper with blade attachment to form a puree.

The beaker was covered to reduce evaporation and placed in a domestic microwave oven at 1200 W and heated for 40 seconds and then at 360 W for a further 80 seconds. The product was cooled to about 30° C. and then sealed in a film pouch of low O₂ transmission excluding all air and frozen. Product colour was bright green, similar to the starting fresh leaves.

When the product was placed in a bowl exposed to air at room temperature for several hours, the colour remained the same with no evidence of browning. A fresh portion of the product ex the freezer was used to coat freshly drained hot pasta and the paste remained green and the pasta showed no browning, even several hours after preparation. When the pasta was washed clean of the pesto coating it was evident that the pasta strand had retained its white colour to the centre.

### Example 8

The following example demonstrates the preparation of a rocket leaf pesto product from fresh rocket leaves made using a method in accordance with an embodiment of the present invention.

| INGREDIENTS | grams |
|---|---|
| Rocket leaves | 50.0 |
| Parmesan Cheese grated | 6.0 |
| Walnuts chopped | 6.0 |
| Garlic finely sliced | 3.0 |
| Salt | 1.0 |
| Sodium Erythorbate | 0.5 |
| Sodium Bicarbonate | 0.5 |
| Olive oil | 10.0 |
| Sunflower Oil | 23.0 |
| ƒ | 100 |

Cleaned fresh rocket leaves with base stems removed were placed into a plastic beaker along with the other ingredients and comminuted in air using a hand-held commercial electric chopper with blade attachment to form a puree.

The beaker was covered with film to reduce evaporation and placed in a domestic microwave oven at 1200 W and heated for 40 seconds and then at 360 W for a further 60 seconds. The product was cooled to about 22-30° C. and then sealed in a film pouch of low O₂ transmission excluding all air and frozen. Product colour was bright green, similar to the starting fresh leaves.

A portion was added to coat a serving of freshly cooked pasta. The bright and deep green colour persisted on the pasta for over 2 hours. The flavour was of typical spicy and peppery taste of fresh rocket.

### Example 9

The following example demonstrates the preparation of a spinach puree product from fresh English spinach leaves made using a method in accordance with an embodiment of the present invention.

| INGREDIENTS | grams |
|---|---|
| Fresh Spinach leaves | 67.0 |
| Salt | 1.2 |
| Sodium Erythorbate | 0.5 |
| Sodium Bicarbonate | 0.5 |
| Sunflower Oil | 31.0 |
| ƒ | 100 |

Cleaned fresh bunches of spinach leaves with base stems removed were placed into a plastic beaker along with the other ingredients and comminuted in air using a hand-held commercial electric chopper with blade attachment to form a puree.

The beaker was covered with film to reduce evaporation and placed in a domestic microwave oven at 1200 W and heated for 40 seconds and then at 360 W for a further 60 seconds. The product was cooled to about 22-30° C. and then sealed in a film pouch of low O₂ transmission excluding all air and frozen. The water activity of the mixture was 0.921, the pH was 7.89 and it was negative for polyphenol oxidase (PPO) activity. Product colour was bright green, similar to the starting fresh leaves. A sample of the processed puree was used to replace the traditional requirement for pre-boiled spinach for use in a fresh pasta recipe. The resultant pasta was bright green compared with the olive green which resulted from using pre-boiled spinach. A sample from the present invention was stored frozen for 3 months where it remained bright green and the cooked pasta had a fresh spinach flavour profile. No browning was observed in the spinach or pasta.

### Example 10

The following example demonstrates the preparation of a broccoli puree product from fresh broccoli florets made using a method in accordance with an embodiment of the present invention.

| INGREDIENTS | grams |
|---|---|
| Fresh broccoli florets | 67.0 |
| Salt | 1.0 |
| Sodium Erythorbate | 0.5 |
| Sodium Bicarbonate | 0.5 |
| Ground white pepper | 0.05 |
| Sunflower Oil | 31.0 |
| ƒ | 100 |

Cleaned fresh broccoli florets with base stems removed were halved lengthwise and placed into a plastic beaker along with the other ingredients and comminuted in air using a hand-held commercial electric chopper with blade attachment to form a coarse puree.

The beaker was covered with film to reduce evaporation and placed in a domestic microwave oven at 1200 W and heated for 40 seconds and then at 360 W for a further 120 seconds. The product was cooled to about 22-30° C. and then sealed in a film pouch of low O₂ transmission excluding all air and frozen. Product colour was a coarse emulsion of mix of cream white pieces and bright green floret tips, similar to the starting fresh product. There was not pinking or browning of the broccoli when the mixture was exposed to ambient air for 2 hours. The product was negative for PPO enzyme activity. The taste was typical of lightly steamed fresh broccoli. Traditional risotto rice was prepared from Arborio rice (1 cup) and water (2 cups) simmered for 25 minutes until creamy but al dente and while still hot ¼ cup of broccoli pesto was stirred in. After 1 hour left on the bench, the broccoli pesto risotto showed no sign of browning and the rice kernels remained white coated with bright green and white pesto.

### Example 11

The following example demonstrates the preparation of an avocado and coriander puree product from fresh avocado flesh and fresh coriander made using a method in accordance with an embodiment of the present invention.

| INGREDIENTS | grams |
|---|---|
| Avocado | 57.0 |
| Coriander | 23.0 |
| Parmesan Cheese | 6.0 |
| Pine nuts | 6.0 |
| Garlic finely sliced | 5.0 |
| Salt | 1.2 |
| Ground White Pepper | 0.05 |
| Sodium Erythorbate | 0.5 |
| Sodium Bicarbonate | 0.5 |
| Olive oil | 8.0 |
| Sunflower oil | 18 |
| ƒ | 100 |

Fresh firm and ripe avocados were peeled, seeded and the flesh diced added to a beaker. Fresh bunches of coriander leaves and stems were washed, spun dry, roughly chopped and added to the avocado. The garlic was thinly sliced and added to the avocado and coriander. The resultant admixture with the remaining ingredients was treated as in Example 1.

When the product was removed from the frozen pack its colour was bright light green, similar to that of the starting fresh leaves and avocado colour mix. When the product was placed in a bowl exposed to air at room temperature for several hours, the colour remained the same with no evidence of browning. The aroma was of fresh coriander and avocado and intense with no off flavours. The taste was typical of fresh coriander and avocado salsa dip. Avocado and coriander are two plant materials that have notoriously active browning enzyme systems, and the inventors consider that this composition, and its properties, is indicative of the general applicability of the present invention to other plant materials.

It will be understood to persons skilled in the art of the invention that many modifications may be made without departing from the spirit and scope of the invention.

It is to be understood that any prior art publication referred to herein does not constitute an admission that the publication forms part of the common general knowledge in the art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-27. (canceled)

28. A method for preparing a ready to use storage stable food composition, the method comprising:
comminuting an admixture of a fresh plant material and an oil at a substantially neutral pH and under conditions whereby browning enzymes in the plant material are substantially prevented from reacting;
rapidly heating the admixture to a temperature at which the browning enzymes are substantially inactivated, under conditions whereby the admixture loses substantially no weight during heating; and
cooling the heated admixture to a temperature at which growth of spoilage organisms does not occur.

29. The method of claim 28, wherein the comminution occurs under anoxic conditions.

30. The method of claim 28, wherein an antioxidant is added to the admixture before comminution.

31. The method of claim 30, wherein the antioxidant is sodium erythorbate, sodium ascorbate, ascorbic acid, vitamin E or a mixture thereof.

32. The method of claim 28, wherein a pH adjusting agent is added to the admixture.

33. The method of claim 32, wherein the pH adjusting agent is added to the admixture in an amount to cause the pH to be between about 6.5 and 7.5.

34. The method of claim 28, wherein the admixture is rapidly heated to a temperature of about 80° C. to about 90° C. for a holding time of between about 30 seconds and about 2 minutes.

35. The method of claim 28, wherein the admixture is rapidly heated to the temperature at which the browning enzymes are substantially inactivated by exposing the admixture to microwave radiation, by exposing the admixture to a hot fluid or by heating the admixture in a heat exchanger.

36. The method of claim 28, wherein the admixture is heated subsequent to comminution.

37. The method of claim 28, wherein the heated admixture is cooled to a temperature of below 0° C.

38. The method of claim 28, wherein the composition is hyperbarically processed after cooling.

39. The method of claim 28, wherein an amount of the oil in the admixture makes a frozen storage stable food composition scoopable.

40. The method of claim 28, wherein the plant material is selected from the group consisting of: a herb, a spice, a fruit, a vegetable and combinations thereof.

41. The method of claim 28, wherein the plant material is herb or spice and is selected from the group consisting of: basil, oregano, sage, marjoram, thyme, rosemary, mint, ginger, chilli, garlic, green peppercorns, coriander and combinations thereof.

42. The method of claim 28, wherein one or more other foods is/are added to the admixture before comminution.

43. The method of claim 28, wherein the ready to use storage stable food composition is a ready to use frozen pesto.

44. A ready to use storage stable food composition, prepared using the method of claim 28.

45. A ready to use storage stable food composition, comprising a comminuted mixture of:
a fresh plant material; and
an oil;
wherein the composition contains substantially no active browning enzymes, has a substantially neutral pH and a water activity greater than 0.91.

46. A ready to use storage stable food composition, comprising a comminuted mixture of:
a fresh plant material; and
an oil;
whereby, when the composition is combined with a food containing phenolic compounds, no browning of the food occurs.

47. A ready to use storage stable food composition, consisting essentially of a comminuted mixture of:
between about 5 and about 90 wt % of a fresh plant material;
between about 10 and about 95 wt % of an oil;
between 0 and about 5 wt % of an antioxidant;
between 0 and about 5 wt % of a pH adjusting agent; and
between 0 and about 60 wt % of other foods,
wherein the composition contains substantially no active browning enzymes, has a substantially neutral pH and a water activity greater than 0.91.
